(19) United States
(12) Patent Application Publication
(10) Pub. No.: US 2026/0009697 A1
(43) Pub. Date: Jan. 8, 2026

(54) METHOD FOR DETERMINING THE TEMPERATURE OF AN INTERNAL COMBUSTION ENGINE

(71) Applicant: SCHAEFFLER TECHNOLOGIES AG & CO. KG, Herzogenaurach (DE)

(72) Inventors: Fabien JOSEPH, Toulouse (FR); Stéphane ELOY, Toulouse (FR)

(73) Assignee: SCHAEFFLER TECHNOLOGIES AG & CO. KG, Herzogenaurach (DE)

(21) Appl. No.: 19/136,602

(22) PCT Filed: Feb. 14, 2024
(86) PCT No.: PCT/EP2024/053679

§ 371 Date: Jun. 6, 2025

(30) Foreign Application Priority Data
Feb. 21, 2023 (FR) FR2301582

(51) Int. Cl. G01M 15/05

(52) U.S. Cl. CPC G01M 15/05

(57) ABSTRACT

A method for determining an operating temperature of an engine, includes the following steps: calibrating the engine by determining an initial corrective angular value (CAV) in order to know the actual position of a camshaft; storing the initial CAV, a calibration temperature and a calibration speed; determining an operating CAV; determining a speed NRef and calculating an equivalent calibration CAV for a speed NRef and an equivalent operating CAV for NRef; calculating an angular difference AD between the equivalent calibration CAV and the equivalent operating CAV; determining the operating temperature on the basis of the difference AD, a CAV varying linearly with the temperature at constant speed according to a slope PTEMP, the temperature corresponding to the calibration temperature increased by the difference AD divided by the slope PTEMP.

### CROSS-REFERENCE TO RELATED APPLICATIONS

This application is the U.S. National Phase application of PCT International Application No. PCT/EP2024/053679, filed Feb. 14, 2024, which claims priority to French Patent Application No. FR2301582, filed Feb. 21, 2023, the contents of such applications being incorporated by reference herein.

### FIELD OF THE INVENTION

The present disclosure relates to a method for determining the temperature of an internal combustion engine. It relates more particularly to four-stroke engines, that is, engines that comprise both a crankshaft and at least one camshaft.

The technical field of the present invention is thus that of engine control for internal combustion engines. To ensure that the engine operates satisfactorily and in particular in order to comply with pollutant emission standards, various engine operating parameters must be controlled, such as the temperature of the fluids ensuring satisfactory operation of the engine for example.

### BACKGROUND OF THE INVENTION

In an internal combustion engine, one or more cylinders are produced in an engine block and each define, with a cylinder head and pistons (one piston for each cylinder), a combustion chamber. For each combustion performed in the engine, the corresponding piston is moved and rotates a crankshaft. In order to control the gas streams entering and leaving each combustion chamber, valves are provided and the opening and closing of these valves are controlled by at least one camshaft.

In order to know the position of the pistons in the engine, it is common practice to use a sensor associated with a target linked to the crankshaft, and a sensor associated with a target linked to a camshaft. Knowledge of this position is essential for satisfactory operation of the engine, together with other parameters including the temperature of the engine coolant. This coolant is usually water (with one or more additives) or oil. The temperature of this fluid is a parameter that is more particularly monitored in an engine, in particular by an on board diagnostic system, or OBD system.

In an internal combustion engine, the temperature of the coolant is conventionally given by a temperature sensor that is connected to a control and management system of said engine. The temperature of the coolant (water or oil) that circulates in the engine and substantially makes the temperature in the engine uniform will be referred to below more generally as the “engine temperature”. Whether this is the temperature of the water or oil (or optionally the temperature given by a specific sensor positioned in a location in which the temperature is significant), this quantity is considered for ease of expression to correspond to a quantity characteristic of the engine.

When the temperature sensor fails (no longer supplies the engine temperature or supplies an incorrect temperature), the engine must then be managed in a degraded mode.

The present disclosure aims to provide means that make it possible to overcome the failure of an engine temperature sensor in an internal combustion engine, that is, means that make it possible to know the engine temperature even in the event of the failure, or absence, of a temperature sensor.

### SUMMARY OF THE INVENTION

According to the present disclosure, a method is proposed for determining an operating temperature of an internal combustion engine comprising a crankshaft, a first target associated with this crankshaft, and a crankshaft position sensor interacting with said first target, and a camshaft, a second target associated with said camshaft, and a camshaft position sensor interacting with said second target,
said method comprising a prior calibration phase having the following steps:
   calibrating the engine by determining an initial corrective angular value corresponding to the difference between an actual position of a protrusion edge of the second target and a theoretical position of said protrusion edge in known or estimated engine temperature and speed conditions,
   storing the initial corrective angular value, a calibration temperature corresponding to the engine temperature during calibration, and a calibration engine speed corresponding to the engine speed during calibration,
said method then comprising engine temperature measurement phases implementing the following steps:
   determining an operating corrective angular value corresponding to the difference between an actual position of a protrusion edge of the second target and a theoretical position of said protrusion edge in known engine speed conditions corresponding to an operating engine speed,
   considering that at constant temperature a corrective angular value varies linearly with the engine speed according to a first known slope depending on the engine type, determining an engine speed NRef and calculating an equivalent calibration corrective angular value of the calibration angular value for the engine speed NRef, and calculating an equivalent operating corrective angular value of the operating angular value for the engine speed NRef,
   calculating an angular difference AD between the equivalent calibration corrective angular value and the equivalent operating corrective angular value,
   determining the engine operating temperature engine on the basis of the angular difference AD, considering that at constant speed a corrective angular value varies linearly with the engine temperature according to a second known slope depending on the engine type, the engine operating temperature corresponding to the calibration temperature increased by the angular difference AD divided by the second slope.

Such a method therefore makes it possible to know the engine temperature solely on the basis of the signals supplied by the crankshaft position sensor and the camshaft position sensor (and the associated electronics).

The reference engine speed can be, for example but non-limitingly, the operating engine speed or the engine speed during calibration.

In a method as described above, the features disclosed in the following paragraphs can optionally be implemented, independently of one another or in combination with one another:
the calibration temperature is a measured temperature;
the prior calibration phase is carried out when the engine is first started up;
the first slope of the linear function of the corrective angular value as a function of the engine speed at constant engine temperature, and the second slope of the linear function of the corrective angular value as a function of the engine temperature at constant engine speed, are determined on a standard vehicle, and the value of the first slope and the value of the second slope are stored;
the internal combustion engine is provided with a variable valve timing system acting on the angular position of a camshaft, and the operating corrective angular value is determined when the angular position of said camshaft is known; in this case, the operating corrective angular value is preferably determined when the engine speed corresponds to an idle speed and/or when the engine is in foot-off conditions.

According to another aspect, a computer program is proposed comprising instructions for implementing a method as described above when this program is executed by a processor, in particular an electronic control unit of an internal combustion engine.

According to another aspect, a non-transitory computer-readable recording medium is proposed, on which such a program is recorded.

According to another aspect, an electronic system for managing an internal combustion engine is proposed, configured to implement all of the steps of a method described above, and comprising:
a crankshaft sensor, configured to detect the passing of the protrusion edges of a crankshaft target;
a camshaft sensor, configured to detect the passing of the protrusion edges of a camshaft target;
a control unit provided with an electronic memory, configured for:
   receiving as an input data supplied by the crankshaft sensor and data supplied by the camshaft sensor;
   supplying instructions for implementing the steps of a method as described above; and
   determining an engine temperature.

According to another aspect, a motor vehicle is proposed, having:
a crankshaft provided with a target and associated with a crankshaft sensor,
a camshaft provided with a target and associated with a camshaft sensor, characterized in that it comprises an electronic system according to the preceding paragraph. In such a vehicle, the internal combustion engine can be provided with a variable valve timing system.

### BRIEF DESCRIPTION OF THE DRAWING

Further features, details and advantages will become apparent on reading the detailed description below, and with reference to the appended drawing, in which:

FIG. 1 is a graph showing a correlation at constant engine speed between a corrective value for an angular position of a camshaft and an engine temperature.

FIG. 2 is a graph showing a correlation at constant engine temperature (for three different temperatures) between a corrective value for an angular position of a camshaft and an engine speed.

FIG. 3A is a graph explaining how to obtain an engine temperature on the basis of a measurement point using a first method according to the present disclosure.

FIG. 3B is a graph explaining how to obtain an engine temperature on the basis of a measurement point using a second method according to the present disclosure.

FIG. 4 is a logic diagram for implementing a method according to the present disclosure.

FIG. 5 is a schematic view of a vehicle for implementing the present disclosure.

### DESCRIPTION OF THE EXEMPLARY EMBODIMENTS

The present description is given in relation to an internal combustion engine, of the four-stroke type. As is known to a person skilled in the art, an internal combustion engine comprises one or more cylinders, each containing a combustion chamber and in each of which slides a piston connected by a connecting rod to a crankshaft. Each combustion chamber is associated with at least one intake valve for managing gas streams entering the combustion chamber and at least one exhaust valve for managing gas streams leaving the combustion chamber. The opening and closing of the valves are controlled by at least one camshaft. One and the same camshaft can control all of the valves, or at least one separate camshaft can be provided for the intake valves and at least one other camshaft is then provided for the exhaust valves. In addition, a variable valve timing (VVT) system is preferably provided. Such a system, known to a person skilled in the art, comprises a motor, for example an electric motor, that makes it possible to introduce an angular offset for a camshaft in a pre-determined angular range relative to a reference position while the camshaft is rotated by the crankshaft.

In order to know the angular position of a camshaft (as a function of the rotation thereof by the crankshaft and if applicable as a function of the offset introduced by the variable valve timing system), it is known practice to rigidly connect a camshaft target to the camshaft in question and to associate therewith a camshaft sensor that makes it possible to determine the angular position of the camshaft target. The target has protrusions on its periphery that usually take the form of teeth. For a camshaft target, the teeth (or more generally protrusions) have a variable angular length and they are not necessarily evenly distributed on the periphery of the target.

Likewise, in order to know the angular position of a crankshaft, it is known practice to rigidly connect a crankshaft target to the crankshaft and to associate therewith a crankshaft sensor that makes it possible to determine the angular position of the crankshaft target. The target has protrusions on its periphery that usually take the form of teeth. For a crankshaft target, the teeth (or more generally protrusions) are usually similar and they are generally evenly distributed on the periphery of the target, apart from the absence of one or two consecutive teeth.

A camshaft sensor is usually separate from a crankshaft sensor. It is therefore necessary to carry out, in a manner known to a person skilled in the art, a calibration to compensate for the effects linked to speed during a phase of learning the position of the camshaft. This is because the sensors (camshaft and crankshaft) have different response times and the speed of rotation of a camshaft is half that of the crankshaft. During the operation of the engine, it is thus known practice to determine a corrective angular value to correct the angular value of the camshaft coming from the signal given by the camshaft sensor.

The present disclosure entirely originally proposes using this corrective angular value, with other data/measurements, to determine the engine temperature. This temperature is given by a temperature sensor. Usually, the temperature of the coolant is taken into account, but another temperature measurement can be taken (oil temperature or specific sensor). The engine temperature is an item of data selected during the design of the engine and makes it possible to check that the engine is in good health. It is also used to optimize the thermal efficiency of the engine and limit polluting emissions. It is also involved in optimizing comfort inside the vehicle.

Due to its importance, the engine temperature is one of the parameters that are monitored in the engine and used to establish a diagnosis relating to a fault. On board diagnostic (OBD) systems particularly monitor this parameter.

In the event of the failure of an engine temperature sensor (absence of data or supply of clearly incorrect data), the engine must operate in a downgraded mode.

The present disclosure makes it possible however to determine the engine temperature in an entirely original manner solely on the basis of the signals supplied by the crankshaft sensor and the camshaft sensor, as explained below.

An operation for learning the position of the edges of the teeth of the camshaft target is carried out so as to determine the actual position of these edges relative to the position given directly by the camshaft sensor. In the case of an engine provided with a variable valve timing (VVT) system acting on the angular position of a camshaft, this learning operation is carried out when said variable valve timing system is in a reference position. This position is a constant mechanical value. However, one original observation behind the present disclosure is that the calculated position (on the basis of the signal from the camshaft sensor) varies with the engine temperature.

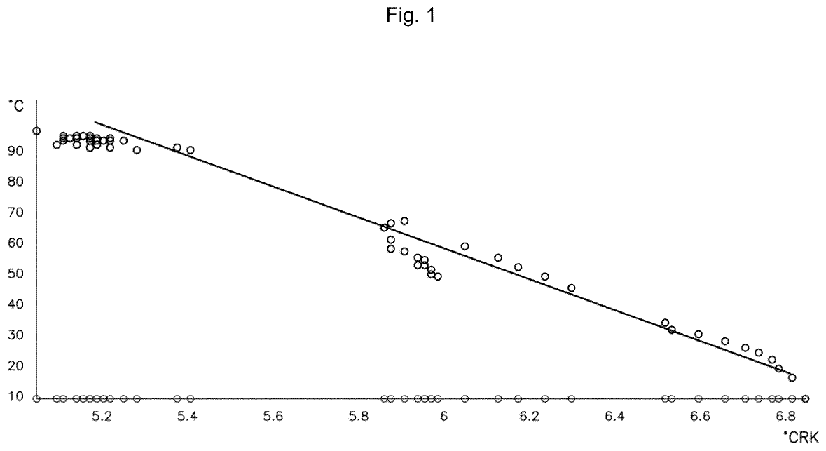

FIG. 1 shows measurement points that were taken at constant speed, that is, the speed of rotation of the crankshaft was constant. In the example illustrated, the speed of rotation was approximately 800 revolutions per minute (rpm), and more specifically, this speed was between 790 and 810 rpm.

In FIG. 1, the horizontal (x) axis shows the value of the correction to be applied to the angular position value of the camshaft in order to obtain the actual position of said camshaft. The vertical (y) axis corresponds to the engine temperature (for example the temperature of the engine coolant).

It will be noted in FIG. 1 that all of the measurement points are grouped around a straight line. By performing a linear interpolations, it is determined that when the engine temperature rises from 10 to 100° C., the corrective angular value (for determining the exact position of the camshaft) varies linearly from 6.8° C. RK (that is, 6.8° of rotation of the crankshaft) to 5.2° C. RK. A first slope PTEMP (in ° C. RK/° C.) is thus determined using the formula:

$$PTEMP = ( 5.2 - 6.8 ) / ( 100 - 10 ) = - 1.6 / 90 = - 0.017 °C . RK / °C .$$

Of course, all of the values given in the present description are purely illustrative and non-limiting values.

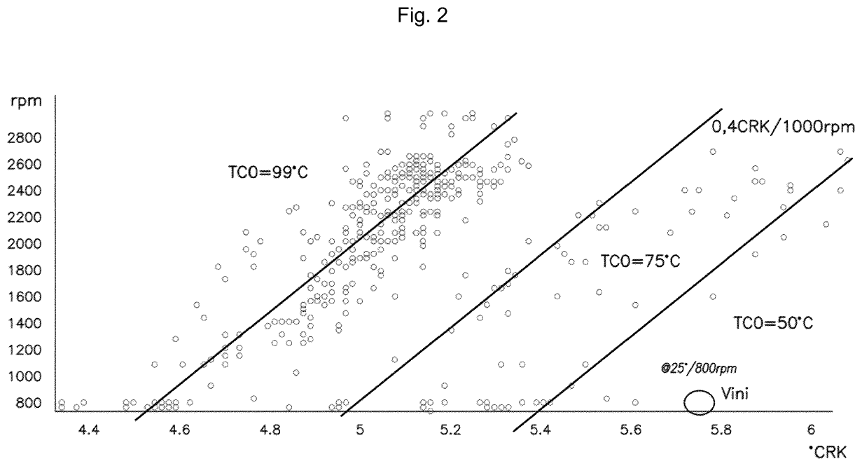

Similarly, when the engine temperature is constant, the corrective angular value varies linearly with the engine speed. This is illustrated by FIG. 2, in which three sets of measurement points are grouped together, a first set of measurement points taken at a temperature of 99° C., a second at 75° C., and a third at 50° C. (the temperatures given are purely illustrative and non-limiting, as are the other numerical values even if this is not specifically stated).

In FIG. 2, here again the x-axis shows the corrective angular values, but the y-axis shows the speed of rotation of the engine.

As illustrated in FIG. 2, three parallel straight lines are obtained by interpolation, which lines therefore have the same slope PRPM. In this exemplary embodiment, as shown in FIG. 2:

$$PRPM = 0.4 °C . RK / 1 , 000 rpm$$

that is, if the corrective angular value determined at a speed of rotation of 2,000 rpm equals 5° C. RK, then at the same engine temperature, determining the corrective angular value will give a value of 5.4° C. RK at 3,000 rpm.

The values PTEMP and PRPM, that is, the variations in the corrective angular values as a function of the engine temperature and the speed of rotation of the engine respectively, are linked to the engine type and do not vary from one engine to another (when these two engines are similar). These values are therefore determined once and for all on a standard vehicle and are then stored in similar vehicles manufactured subsequently.

In order to then determine the engine temperature on a particular engine, a reference must be created that takes into account the assembly tolerances. A measurement point of the corrective angular value when the engine speed and engine temperature are known must thus be determined as soon as possible.

It is thus proposed that the corrective angular value be measured in order to create said reference when the engine is first started up. A number of adjustments are planned during this first start-up. It is thus a procedure that does not interfere with the manufacturing of a vehicle. This first start-up takes place as the vehicle leaves the factory, and the engine temperature is therefore even. Here, it can be assumed that the engine temperature probe, which is brand new, gives a reliable temperature. In the absence of a temperature sensor, this temperature can be estimated. In the illustrative figures, the engine temperature on this first measurement is 25° C.

This first measurement is thus taken during a calibration phase. Generally, during the first start-up, the engine is left to operate at idle. If the engine is provided with a variable valve timing system acting on the angular position of a camshaft, this system is not active and the camshaft is in its reference position.

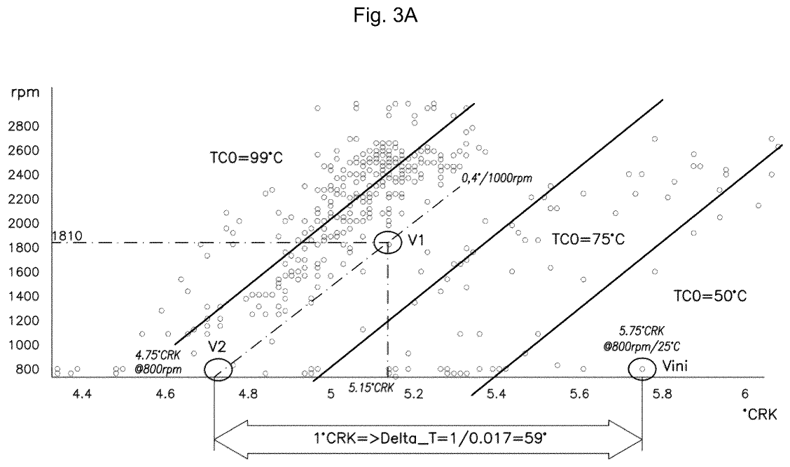

In these conditions, as illustrated in FIGS. 2 and 3 (3A and B), a reference point Vini is obtained that has the following characteristics (purely by way of illustration):
calibration corrective angular value of 5.75° C. RK
at a calibration temperature of 25° C.
measured at a calibration engine speed of 800 rpm.

These values are then stored in a memory of an electronic unit used for engine management and also known as a CPU.

The determining of the engine temperature is now described with reference to FIG. 3A.

FIG. 3A shows the point Vini.

Preferably as soon as possible, an operation for learning the actual position of the camshaft is carried out. To this end, the camshaft must be in a stable, known position, for example its reference position. The learning operation is also preferably carried out at substantially constant speed. These conditions are for example met when the engine is idling or in foot-off conditions, that is, when the driver removes their foot from the accelerator. The learning operation then takes place. As for the first calibration during the first start-up of the engine, a dozen engine revolutions are generally sufficient to obtain the corrective angular value.

In the example illustrated, a learning operation is carried out at an operating speed of 1,810 rpm and supplies the measurement point V1 with an operating corrective angular value of 5.15° C. RK.

In order to find the engine temperature on the determining of the measurement point V1, it is proposed to “slide” the point V1 on the line of constant temperature of slope PTEMP in the graph (Corrective angular value-engine speed) in FIG. 3A until a line D1 is reached of equation

$$Engine speed = NRef$$

In FIG. 3A, the value selected for NRef is the value of 800 rpm corresponding to the calibration engine speed.

The point at the intersection of the isotherm and the straight line D1 is denoted V2 in FIG. 3A. The difference in engine speed between the operating engine speed for determining the point V1 and the calibration engine speed is 1,010 rpm. The point V2 is therefore on the x-axis (5.15-PRPM*1.01), i.e. 4.75° C. RK.

Since V2 and Vini are on the same straight line D1, which is a line of constant speed, here the difference on the x-axis between V2 and Vini gives the difference between the corresponding temperatures of the isotherms passing through V2 and Vini using the slope PTEMP defined on the standard car.

In the present numerical example, the difference on the x-axis between V2 and Vini is 1° C. RK. The temperature difference delta_T between the two lines of constant temperature passing through these points is given by

$$Delta\_T = ( 4.75 - 5.75 ) / PTEMP$$

i.e.

$$Delta\_T = 1 / 0.017 = 59 °C .$$

As the calibration temperature is 25° C., the engine temperature on the determining of the measurement point V1 was:

$$T = 25 + 59 = 84 °C .$$

FIG. 3B illustrates a variant that also makes it possible to determine the engine temperature during an operation for learning the actual position of the camshaft on the basis of the corrective angular value determined during this learning operation.

Here, it is assumed that the learning operation supplies the same measurement point V1 as for FIG. 3A, that is, the learning operation is carried out at a speed of 1,810 rpm and gives a corrective angular value of 5.15° C. RK.

The idea in the present disclosure is to move the point V1 and/or the point Vini on their respective isotherms in order to bring them onto one and the same line of constant speed (straight line parallel to the x-axis in FIG. 3). Once on this line of constant speed, as indicated above, the difference on the x-axis between the two moved points makes it possible to know the temperature difference of the corresponding isotherms. Both points V1 and Vini can be moved. However, in order to simplify the calculations, it is preferable to move only one of them. In the example in FIG. 3A, the point V1 has been moved to bring it onto the same line of constant speed as the point Vini. In FIG. 3B, the point Vini is brought onto the line of constant speed of V1. The point Vini is then moved along the line of constant temperature T=25° C. to arrive on the line of constant speed corresponding to the calibration engine speed, that is, 1,810 rpm.

Taking into account the slope PRPM of the lines of constant temperature on the diagram in 3B, the point Vini is moved to the position V3 corresponding to the intersection of the line of constant temperature @ 25° C. and the line of constant speed @ 1,810 rpm. The position on the x-axis of the point V3 is therefore given by:

$$5.75 °C . RK + {PRPM}^{*} 1.01 = 6.15 °C . RK$$

Again, a difference on the x-axis of 1° C. RK is found, which as seen above corresponds to a temperature difference Delta_P of 59° C. The engine temperature is thus also 84° C. here.

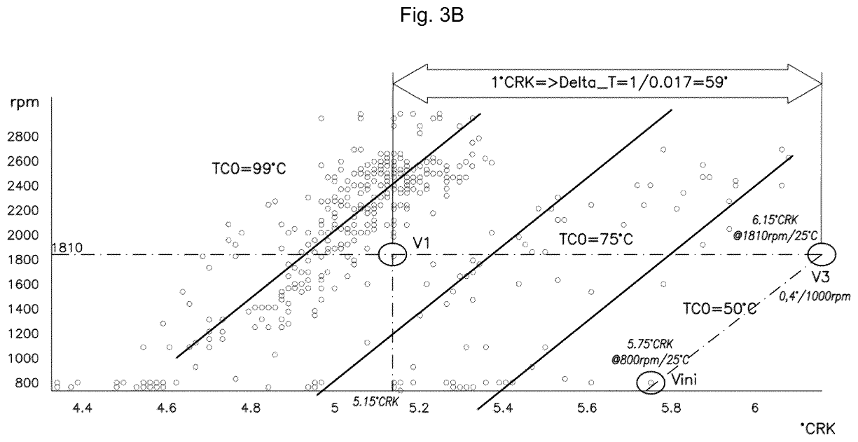

FIG. 4 summarizes the different steps used to obtain the temperature of an internal combustion engine on the basis of the signals supplied by a crankshaft sensor and by a camshaft sensor.

Here, an internal combustion engine is considered, comprising a crankshaft, a first target associated with this crankshaft, and a crankshaft position sensor interacting with said first target, and a camshaft, a second target associated with said camshaft, and a camshaft position sensor interacting with said second target.

As is known, due to both the nature (which can be different) of the sensors used in conjunction with the crankshaft target and the camshaft target and the different speeds of rotation of the crankshaft and the camshaft, it is known practice to determine a corrective angular value in order to know the exact position of the camshaft relative to the crankshaft on the basis of the signal supplied by the camshaft sensor.

A first step 100 corresponds to determining the law that exists between the corrective angular values and the engine speed, and between the corrective angular values and the engine temperature. This law is substantially linear and this is the assumption that is made hereinafter. The slopes of the straight lines representing the variation of the corrective angular value as a function of the engine speed (slope PRPM) and as a function of the engine temperature (slope PTEMP) must therefore be determined. Preferably, these values are determined by means of tests on a standard car. However, other methods can be envisaged, for example simulation. The creation of a table that groups together the slope values as a function of the sensors used can also be envisaged. For this first step 100, the values in said table must simply be read. The PRPM and PTEMP values are then stored in a memory of a management unit of the engine in question.

A second step 200 is a calibration step. Here, preferably as soon as possible, a triplet of values (calibration corrective angular value; calibration engine speed; calibration engine temperature) is determined for the engine in question. This second step also provides for storing this triplet in a memory of the aforementioned management unit of the engine.

This second step 200 is carried out once and for all, preferably when the engine is first started up. Generally, other calibrations are carried out during this start-up.

A third step is carried out repetitively, preferably as soon as the conditions are met for determining a corrective angular value. This third step is sub-divided into sub-steps in order to supply the engine operating temperature at the end.

A first sub-step 310 comprises determining an operating corrective angular value corresponding to the difference between an actual position of a tooth edge of the second target and a theoretical position of said tooth edge in known engine speed conditions. During this first learning sub-step 310, the engine speed preferably varies little (for example ±1% or ±2%) and the average speed (or average velocity) during this sub-step is stored.

A second sub-step 320 comprises determining a reference engine speed NRef and calculating an equivalent calibration corrective angular value of the calibration angular value for the engine speed NRef, and an equivalent operating corrective angular value of the operating angular value for the engine speed NRef. On a graph showing the corrective angular values and engine speeds, provision is therefore made here to move the point (calibration corrective angular value; calibration engine speed) corresponding to the measurement taken in step 200 on its isotherm, and/or to move the point (operating corrective angular value; operating engine speed) on its isotherm, to bring them onto one and the same straight line for which the engine speed equals NRef. Preferably, the reference engine speed NRef is selected from the following two values: calibration engine speed or operating engine speed. In this case, a single point on the graph is moved.

A third sub-step 330 then corresponds to calculating an angular difference AD between the equivalent calibration corrective angular value and the equivalent operating corrective angular value. This difference AD corresponds to an angular value in ° CRK, that is, an angular difference measured at the crankshaft.

The fourth and last step 340 is then a step of determining the engine operating temperature on the basis of the angular difference AD, considering that at constant speed a corrective angular value varies linearly with the engine temperature according to the slope PTEMP, the engine operating temperature corresponding to the calibration temperature increased by the angular difference AD divided by the slope PTEMP.

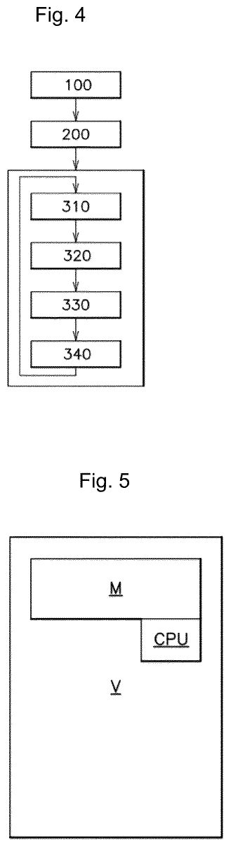

The method described above is preferably implemented by an electronic unit on board a vehicle, for example a motor vehicle. This electronic unit can be referred to as the management unit and is also known as the CPU. FIG. 5 schematically illustrates a vehicle V powered by an engine M, said engine being electronically controlled by at least one electronic unit CPU. The engine M is an internal combustion engine comprising at least one camshaft that can be associated with a variable valve timing system, for example a variable valve timing system that implements an electric motor in order to vary the valve timing.

### INDUSTRIAL APPLICATION

The present technical solution can be applied in particular to engine control.

In an entirely original manner, it is proposed herein to determine an engine temperature solely using the sensors (and the associated electronics) associated with a crankshaft target and a camshaft target.

It is also possible to allow normal management of the engine even in the event of the failure of a temperature sensor intended to supply the temperature of the engine in question.

Here, it is thus possible when designing an engine to save on a temperature sensor and determine the engine temperature solely as explained in the present disclosure.

The present disclosure is not limited to the proposed embodiments and to the variants described above, which are provided solely by way of example, but encompasses all of the variants that could be envisaged by a person skilled in the art within the scope of the protection sought.

1. A method for determining an operating temperature of an internal combustion engine comprising a crankshaft, a first target associated with this crankshaft, and a crankshaft position sensor interacting with said first target, and a camshaft, a second target associated with said camshaft, and a camshaft position sensor interacting with said second target,
said method comprising a prior calibration phase having the following steps:
calibrating the engine by determining an initial corrective angular value corresponding to the difference between an actual position of a tooth edge of the second target and a theoretical position of said tooth edge in known or estimated engine temperature and speed conditions,
storing the initial corrective angular value, a calibration temperature corresponding to the engine temperature during calibration, and a calibration engine speed corresponding to a value representing the engine speed during calibration,
said method then comprising engine temperature measurement phases implementing the following steps:
determining an operating corrective angular value corresponding to the difference between an actual position of a tooth edge of the second target and a theoretical position of said tooth edge in known engine speed conditions corresponding to an operating engine speed,
considering that at constant temperature a corrective angular value varies linearly with the engine speed according to a first known slope (PRPM) depending on the engine type, determining a reference engine speed NRef and calculating an equivalent calibration corrective angular value of the calibration angular value for the reference engine speed NRef, and calculating an equivalent operating corrective angular value of the operating angular value for the reference engine speed NRef,
calculating an angular difference AD between the equivalent calibration corrective angular value and the equivalent operating corrective angular value,
determining the engine operating temperature engine on the basis of the angular difference AD, considering that at constant speed a corrective angular value varies linearly with the engine temperature according to a second known slope (PTEMP) depending on the engine type, the engine operating temperature corresponding to the calibration temperature increased by the angular difference AD divided by the second slope.

2. The method as claimed in claim 1, wherein the calibration temperature is a measured temperature.

3. The method as claimed in claim 1, wherein the prior calibration phase is carried out when the engine is first started up.

4. The method as claimed in claim 1, wherein the first slope (PRPM) of the linear function of the corrective angular value as a function of the engine speed at constant engine temperature, and the second slope (PTEMP) of the linear function of the corrective angular value as a function of the engine temperature at constant engine speed, are determined on a standard vehicle, and in that the value of the first slope (PRPM) and the value of the second slope (PTEMP) are stored.

5. The method as claimed in claim 1, wherein the internal combustion engine is provided with a variable valve timing system acting on the angular position of a camshaft, and in that the operating corrective angular value is determined when the angular position of said camshaft is known.

6. The method as claimed in claim 5, wherein the operating corrective angular value is determined when the engine speed corresponds to an idle speed and/or when the engine is in foot-off conditions.

7. An electronic system for managing an internal combustion engine, configured to implement all of the steps of a method as claimed claim 1, and comprising:
a crankshaft sensor, configured to detect the passing of the protrusion edges of a crankshaft target;
a camshaft sensor, configured to detect the passing of the protrusion edges of a camshaft target;
a control unit provided with an electronic memory, configured for:
receiving as an input data supplied by the crankshaft sensor and data supplied by the camshaft sensor;
supplying instructions for implementing the steps of a method as claimed in one of claims 1 to 6; and
determining an engine temperature.

8. A computer program comprising instructions which, when the program is executed by a computer, cause the computer to implement all of the steps of a method as claimed in claim 1.

9. A motor vehicle comprising an internal combustion engine having:
a crankshaft provided with a target and associated with a crankshaft sensor,
a camshaft provided with a target and associated with a camshaft sensor,
and comprising an electronic system as claimed in claim 7.

10. The motor vehicle as claimed in claim 9, wherein the internal combustion engine is provided with a variable valve timing system.

11. The method as claimed in claim 2, wherein the prior calibration phase is carried out when the engine is first started up.
